(19) United States
(12) Patent Application Publication
(10) Pub. No.: US 2001/0036426 A1
(43) Pub. Date: Nov. 1, 2001

(54) Arrangement for the contamination-free processing of reaciton sequences, in particular molecular-biological reaction sequences, closure carrier and individual closure elements for such an arrangement, and storage and dispensing arrangement for individual closure elements

(76) Inventors: Gunter Kohrmann, Kreuzwertheim (DE); Peter Mahler, Kreuzwertheim (DE); Antonio Romaguera, Faulbach (DE)

Correspondence Address: NIXON PEABODY, LLP, 8180 GREENSBORO DRIVE, SUITE 800, MCLEAN, VA, 22102, US

(21) Appl. No.: 09/801,930

(22) Filed: Mar. 9, 2001

(30) Foreign Application Priority Data
Mar. 9, 2000 (DE) 100 13 240.5

(51) Int. Cl. B01J 19/00

(52) U.S. Cl. 422/130; 422/102; 422/131; 422/100

(57) ABSTRACT

The objective of the invention is an arrangement for the contamination-free processing of molecular-biological reaction sequences, consisting of several reaction vessels (2), open at the top, arranged next to one another and connected to one another, an individual closure element (3) per reaction vessel (2) with a closure section (4) to provide a tight seal of the aperture of the reaction vessel (2) and an actuation section (5) for engaging at the individual closure element (3) and a closure carrier (6) covering all the reaction vessels (2) or groups of reaction vessels (2), each with a socket (7) for the actuation section (5) of each individual closure element (3) for securing the individual closure element (3) to the closure carrier (6), whereby the individual closure elements (3) secured to the closure carrier (6) are capable of being placed with sealing effect together with the closure carrier (6) onto the reaction vessels (2), and can be withdrawn therefrom. In terms of handling technology in the sense of an individual opening capability of the reaction vessels (2), this arranged is improved according to the invention in that the closure sections (4) of the individual closure elements (3) are capable of being inserted through the sockets (7) in the closure carrier (6) in both directions, and that the individual closure elements (3) are secured to the closure carrier (6) in such a way that, with the closure carrier (6) with individual closure elements placed on the reaction vessels (2), each individual closure element (3) is capable of being removed individually from the closure carrier (6) and from the reaction vessel (2).

### BACKGROUND OF THE INVENTION

1. Field of the Invention

The invention is directed to an arrangement for the contamination-free processing of, in particular, molecular-biological reaction sequences. The objective of the invention is also a corresponding closure carrier. An individual closure element for such an arrangement and a storage and dispensing arrangement for such individual closure elements.

2. Description of Related art

Arrangements for the most contamination-free possible processing of reaction sequences have long been much in demand, in particular for series investigations in molecular biology as well as in adjacent sectors of analytics, for example in the health sector, the foodstuffs chemical sector, and environmental chemistry. In this situation, contamination, in particular cross-contamination in the handling of reaction vessels, is a considerable problem. In particular with especially low-concentrate and/or little modified reaction samples, contamination has a powerful effect on the result of analysis.

One particularly problematic area is nucleic acid diagnostics, in which the avoidance of contamination is very important. In this situation, particular significance is attached to modern reproduction processes, such as, for example, polymerase chain reaction, by means of which the proof limit is substantially reduced. In return, however, the risk increases of falsification of the measurement results due to the contamination sources referred to. Reference may be made in general terms with regard to the background to the processes of nucleic acid diagnostics in particular to EP 0 676 643 A2, from which extensive further references may be drawn.

From the point of view of processing technology it is of interest to make use of an arrangement of several reaction vessels, connected to one another and open to the top, with reaction vessel closure elements, in particular what are referred to as microtitre plates, with corresponding large-surface closure covers. Such manually removable common closure covers have the disadvantage that, when the microtitre plates are opened, spurts from one reaction vessel may pass into an adjacent reaction vessel, which is precisely what should be avoided (prior art in EP 0 676 643 A2, as well as WO 99/44.745 and, for a strip arrangement, U.S. Pat. No. 5,683,659 A). With these arrangements there is the added disadvantage that the individual reaction vessels cannot be opened individually, although this may occasionally be desirable for technical analytical reasons.

Taking the difficulties enunciated heretofore into consideration, it has already been proposed that work be conducted with several reaction vessels, open to the top, arranged next to one another and connected to one another, in particular in the nature of a microtitre plate, but closing these individually by means of an individual closure element, whereby the individual closure elements can then in turn be handled automatically (EP 0 676 643 A2 and EP 0 734 769 A1). This naturally has the disadvantage that the handling of the large number of individual closure elements is elaborate and complex.

Most recently, an arrangement has been proposed of a large number of reaction vessels (WO 00/02.661), in which the reaction vessels are designed with a plastic carrier platform as a plastic component, but are connected to the carrier platform by means of predetermined break points. By breaking the predetermined break points, the individual reaction vessels can be separated one single time from the carrier, in order then to be handled separately. This technique is only suitable for a few diagnostic processes, because the arrangement is destroyed after a reaction vessel has been broken off at the corresponding point. Another proposal (EP 0 976 453 A2) attempts to avoid cross-contamination by way of glass inserts with permanently-fitted closure elements. The closure elements are integral constituent parts of a closure carrier assembly. Each closure element features a thin membrane, through which the interior of the reaction vessel can then also be reached with a needle or similar item, if, as proposed here, the individual closure elements always remain in place.

With the arrangement for contamination-free processing of molecular biological reaction sequences in particular, which the invention takes as the starting point (U.S. Pat. No. 4,599,314 A), the problem of contamination and cross-contamination, as recognised therein (column 1, lines 63 to 66) is already taken into account by individual closure elements of the reaction vessels connected to one another, in particular in the manner of a microtitre plate. In this situation, one advantage from the point of view of handling technology is achieved in that, in addition to the individual closure elements, a closure carrier covering all the reaction vessels is provided for, with in each case an accommodation point for the actuation section of each individual closure element, for securing the individual closure element to the closure carrier. The individual closure elements are in this case held at the closure carrier by a single-piece or multi-piece adhesive film, and can therefore be placed in position to provide a seal, jointly by the closure carrier, all together onto the reaction vessels, or can also be removed again, jointly or in groups, by the closure carrier from the reaction vessels. If the adhesive film is removed, the individual closure element in each case remains on the reaction vessel, forming a seal.

The individual closure elements of the prior art as described heretofore are designed as overlapping covers, in other words such that the individual closure section in each case overlaps the open end of the reaction vessels at the edges. To do this, the reaction vessels must feature an edge which projects upwards from the connection plane of the reaction vessels. In other words, the arrangement with the reaction vessels in this prior art is not a typical microtitre plate, which is designed flat on the upper face.

With the arrangement described heretofore, forming the starting point for the arrangement providing the teaching, for the contamination-free processing of molecular biological reaction sequences in particular, one problem arises in the fact that, for the selective opening of an individual reaction vessel, the adhesive film for all the reaction vessels must first be removed, and the closure carrier then taken away if it is to be guaranteed that, to avoid contamination, all other reaction vessels remain closed. The teaching is therefore aimed at eliminating this problem. The problem indicated is resolved with the arrangement according to the teaching of the present invention with the features set forth in claim 1. An important factor is the recognition that the dimensions of the closure sections of the individual closure elements on the one hand, and the accommodation points in the closure carrier on other, must be matched to one another in such a way that the closure sections can be inserted through the accommodation points and are therefore capable of being removed again. If the individual closure elements are then secured to the closure carrier in such a way that the individual closure elements can also be released individually from the closure carrier with the closure carrier in place on the reaction vessels, then each reaction vessel in the arrangement according to the invention can be opened individually at will or closed again later. This handling technique takes account to an outstanding degree of the requirements of nucleic acid diagnostics in particular, and avoids all contamination and cross-contamination in a truly reliable manner and without particular elaboration.

Preferred embodiments and further embodiments of the teaching expounded heretofore are the object of the sub-claims.

Objects of the invention are, moreover, also the individual parts of an arrangement of the type in question, i.e. in particular the closure carrier and the individual closure elements.

The object of the invention, finally, is also a storage and dispensing arrangement for individual closure elements, since it has been shown, according to the invention, that the individual closure elements can also be used on the reaction vessels individually, i.e. without the closure carrier, as is of course inherently known from the prior art cited in the preamble (EP 0 676 643 A2, EP 0 734 769 A1).

The invention is explained in greater detail hereinafter on the basis of drawings relating to one single example.

### BRIEF DESCRIPTION OF THE DRAWINGS

FIG. 1 In a diagrammatic perspective view, a first arrangement of reaction vessels open to the top, connected to one another, in this case in the form of a microtitre plate with 96 reaction vessels,

FIG. 2 A complete arrangement according to the invention in one embodiment,

FIG. 3 A closure carrier of an arrangement according to the invention, according to FIG. 2,

FIG. 4 An embodiment of an individual closure element capable of use with the arrangement from FIG. 2, in a side view,

FIG. 5 The individual closure element from FIG. 4, in a perspective view from above,

FIG. 6 An enlarged side view of an actuation tool for the handling of an individual closure element,

FIG. 7A diagrammatic representation of a storage and dispensing arrangement for individual closure elements according to the invention.

### DETAILED DESCRIPTION OF THE INVENTION

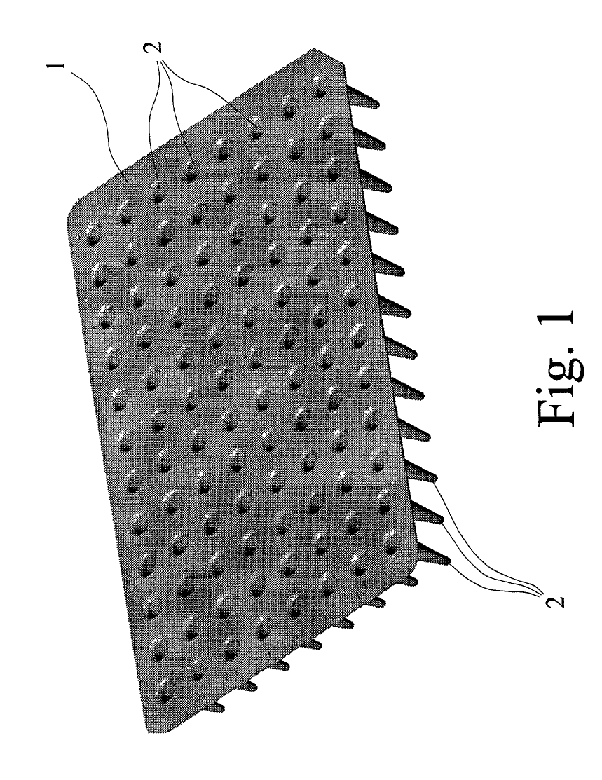

The microtitre plate represented in FIG. 1 for 96 reaction vessels for small and extremely small volumes of specimen liquid is an example of an arrangement of reaction vessels connected to one another, which is not to be understood as restrictive. Strip-shaped arrangements of several reaction vessels connected to one another are also the objective of the invention.

The microtitre plate 1 shown in perspective in FIG. 1, as an arrangement of small reaction vessels 2, open to the top and connected to one another, is well-suited, for example, for the performance of PCR technology as explained in extensive detail in the prior art (see, for example, EP 0 676 643 A2). The accommodation capacity of a reaction vessel 2 in this embodiment is about 200 to 400 μl, but this too is not to be understood as restrictive.

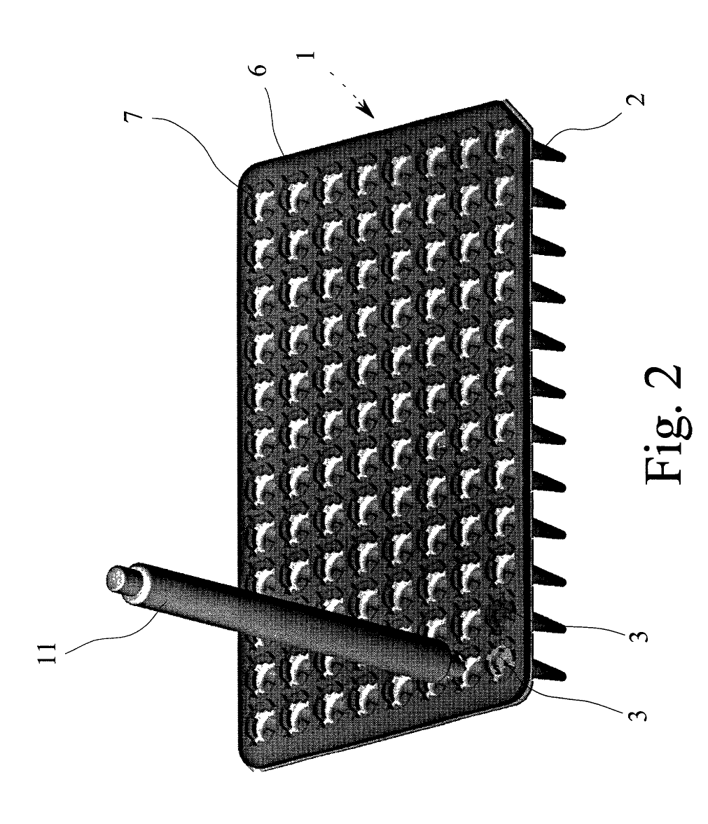

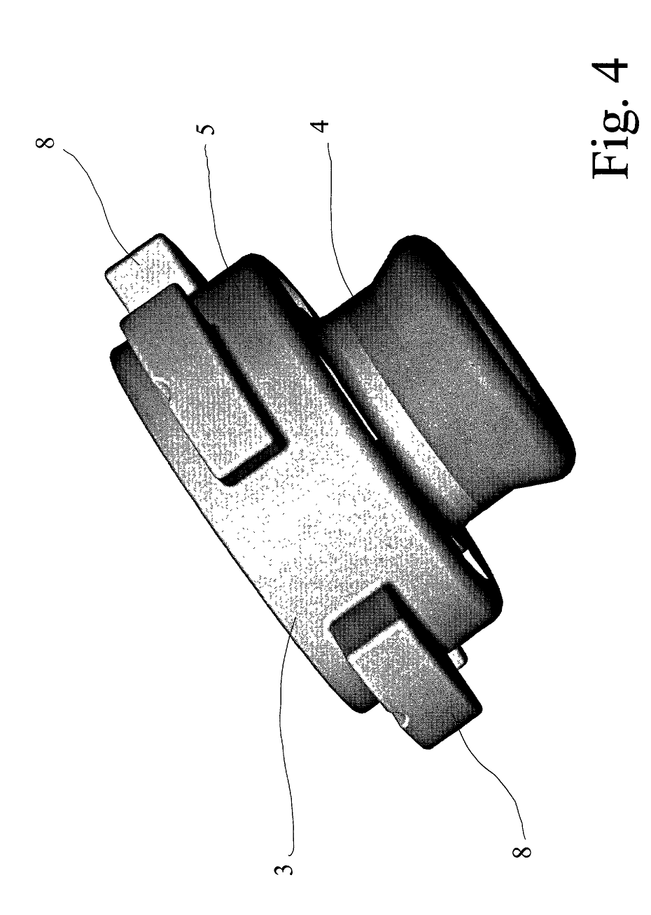

FIG. 2 shows that, with the arrangement according to the invention, an individual closure element 3 is allocated to each reaction vessel 2. FIG. 4 shows such an individual closure element 3 in a side view. It can be seen that the individual closure element 3 features a closure section 4 to provide a tight seal for the aperture of the reaction vessel 2, as well as an actuation section 5 for engaging at the individual closure element 3 for the purpose of handling.

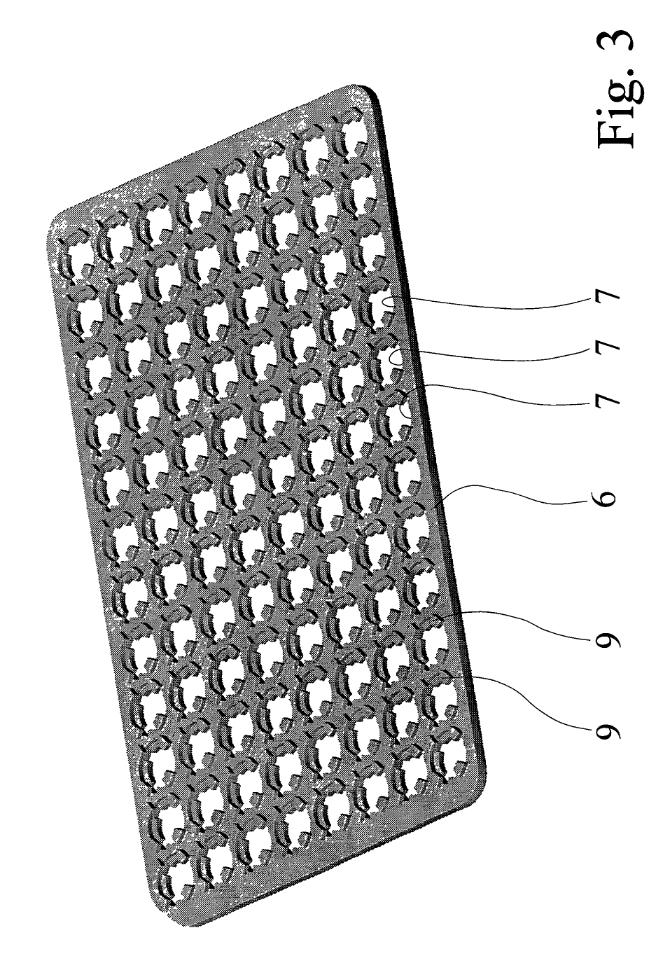

FIGS. 2 and 3 further show closure carriers 6 covering all the reaction vessels 2 of the microtitre plate 1, each with a socket 7 for the individual activation section 5 of each individual closure element 3, for securing the individual closure element 3 to the closure carrier 6. The closure carrier 6 can also cover only one group of reaction vessels 2, so that the overall arrangement then features several closure carriers 6.

The individual closure elements 3 secured to the closure carrier 6, as shown in FIG. 2, are capable of being set jointly with the closure carrier 6 onto the reaction vessels 2, i.e. the microtitre plate 1, so as to form a seal, but can also be drawn off these again jointly with the closure carrier 6.

FIGS. 2, 3, and 4 in conjunction now allow it to be seen that provision is made, with the teaching of the invention, for the closure sections 4 of the individual closure elements 3 to be capable of being inserted through the socket 7 in the closure carrier 6, i.e. they do not collide with the closure carrier 6 at insertion and removal from the closure carrier 6. With the actuation sections 5, the individual closure elements 3 are further secured to the closure carrier 6 in such a way that, with the closure carrier 6 placed on the reaction vessels 2, together with the individual closure elements 3, each individual closure element 3 is also capable of being removed individually from the closure carrier 6 and from the reaction vessel 2 allocated to it. In other words, according to the invention the closure carrier 6 is an independent “cover carrier”, on which the individual closure elements 3 are located in a detachable manner such that they can be individually removed even with the closure carrier 6 being located on the reaction vessels 2. This allows for the individual opening of each reaction vessel 2 with the other reaction vessels 2 remaining closed. This has the advantages described in the general section of the Description, and, in particular, avoids any cross-contamination.

There are of course a variety of possibilities for securing the individual closure elements 3 to the closure carrier 6 within the framework of the teaching. The embodiment shown and to this extent preferred shows, in this context, that the individual closure elements 3 are secured to the closure carrier 6 by means of a releasable positive-fit connection 8, 9, between the actuation section 5 and the socket 7. This can be appreciated particularly well in a joint survey of FIGS. 2, 3, and 4. The lateral dimensions of the socket 7 and the securing section 5 of the individual closure element 3 are selected, in the embodiment shown and preferred, in such a way, and the positive-fit connection 8, 9, is designed in such a way, that, with the individual closure element 3 placed in the socket 7, they allow for a slight lateral displacement of the individual closure element 3 in the socket 7. This slight translatory displacement possibility allows for a precise positioning of the closure sections 4 of all the individual closure elements 3 in the individual reaction vessels 2. This applies in particular if, when the closure carrier 6 provided with the individual closure elements 3, closes the reaction vessels 2 progressively row by row. The slight relative displacement permitted between the closure carrier 6 and the individual closure element 3 particularly facilitates this process if a relatively rigid plastic material is used for the closure carrier 6.

In FIGS. 2, 3, and 4, it can be seen for the positive-fit connection 8, 9, specifically that these are designed in bayonet fashion, whereby the tenon section 8 of the positive-fit connection 8, 9 is arranged at the individual closure element 3, while the link section 9 of the positive-fit connection 8, 9, forms the socket 7 of the closure carrier 6. The link sections 9 can be identified as edges of the sockets 7 in the closure carrier 6 in FIG. 3. It can be appreciated how the tenon sections 8 at the actuation section 5 of the individual closure element 3 in FIG. 4 run in bayonet fashion into the corresponding link sections 9 at the socket 7 pertaining to them. In one rotational position, therefore, the positive-fit connection 8, 9, is closed in the embodiment shown, in a rotational position offset by 45° the positive-fit connection 8, 9, is opened, and the individual closure element 3 can be withdrawn upwards from the socket 7 in the closure carrier 6. In the present case, four tenon parts 8 are provided for at one actuation section 5, but it is of course also possible to work with another number. The number of tenon parts 8 and link parts 9 determines the angle of rotation required to effect release or closure.

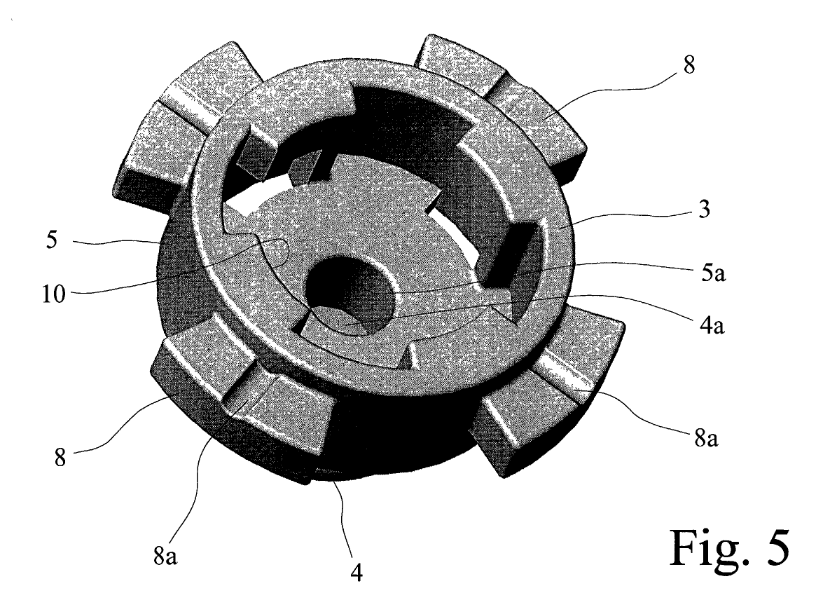

A normal bayonet closure reaches its closed position by way of a rotational movement in one direction and its opening position by a rotational movement in the opposite direction. Such a bayonet closure can also be used according to the invention for the positive-fit connection 8, 9. The preferred embodiment shows a design, however, in which the bayonet closure is capable of actuation in both directions of rotation, and does not feature a stop but a latch arrangement 8a which can be overcome. The latch arrangement 8a can be identified at each tenon part 8 in FIG. 5. With this design, the operator is at liberty with regard to which direction of rotation he wishes to actuate the bayonet closure; the other function position of the bayonet closure is always reached in each case.

As an alternative, a quick screw connection, such as a quadrant screw connection, can also be considered as the positive-fit connection 8, 9, as well as a type of snap connection.

In principle it is also possible for the individual closure elements 3 to be secured to the closure carrier 6 by means of a non-positive connection. The non-positive closure of such a connection should then be of such a size, however, that the closure carrier 6 with all the individual closure elements 3 can be placed without further ado onto the reaction vessels 2 such as to form a seal, and can be withdrawn from them again. Because these force relationships are difficult to match correctly, as is already known from the known silicone mats as collective closure elements (WO 99/44.747), in practice it is the positive-fit connections 8, 9, applied in the embodiment, which will be selected.

FIG. 2 indicates and FIG. 5 shows more clearly, with the individual closure element 3 also, that the individual closure element 3, in particular and shown here at the actuation section 5, features a closure element handling device 10 for engaging an actuating tool 11, which serves to handle an individual closure element 3. In the embodiment shown, the actuating tool 11 is indicated as a rod-shaped manual tool. Use is also made, however, for more extensive handling operations, of automatically-moved and actuated actuation tools 11, as is known from the prior art.

In the embodiment shown, provision is made for the closure element handling device 10 to be designed as a positive-fit closure element, to which a corresponding positive-fit closure element 12 on the actuating tool 11 corresponds. Put more precisely, in the embodiment shown the closure element handling device 10 is designed as a component, namely in this case as a link element, of a bayonet connection. The positive-fit element 12 at the actuation tool 11 is designed as the other part, in particular the tenon part, of the bayonet closure element.

For the design of the closure handling device 10 and the corresponding positive-fit closure element 12, the embodiment represented shows a conventional traditional bayonet closure design. Provisions should accordingly be made, to the purpose, such that after the establishment of the bayonet closure engagement a rotation of the individual closure element 3, inserted in the socket 7, is effectively possible in both directions, so that the right-left insensitivity of the positive-fit connection 8, 9, achieved according to the invention with the preferred embodiment, can also be exploited.

For the handling of the individual closure elements 3, likewise, the other options also apply, whether in positive-fit design or in non-positive format, as have already been explained.

The embodiment shown and preferred shows in particular in FIGS. 4 and 5 that at the individual closure element 3 the positive-fit connection 8, 9, or the non-positive fit connection is arranged on the outside at the actuation section 5, while the closure element handling device 10 of the individual handling element 3 is arranged on the inside. This corresponds to the arrangement identifiable in FIGS. 2 and 3 of the individual closure elements 3 in embedding in the sockets 7 in the closure carrier 6.

With regard to the interaction of the closure section 4 of an individual closure element 3 with the open end of the reaction vessel 2 pertaining to it, it is possible, as with the prior art, for provision to be made for the closure section 4 of the individual closure element 3 to overlap the reaction vessel 2. The embodiment shown and preferred shows, however, a design which is characterised in that the closure section 4 of the individual closure element 3 enters into the open end of the reaction vessel 2 in the manner of a plug. This too is inherently known from the prior art. This allows for a particularly purposeful conception to be achieved, realised in this embodiment, that the securing sections 5 of the individual closure elements 3 consist of a relatively hard and rigid plastic material, the closure sections 4 are formed to provide a material fit, and consist of a relatively soft rubber-elastic plastic material. FIG. 4 shows this indicated by the distinct grey shading of the two sections 4, 5. This enables an optimum sealing effect to be achieved in the closure section 4, and at the same time guarantees simple handling capability to the purpose of the individual closure elements 3 in connection with the closure carrier 6. The latter is also intended to consist of a relatively hard and rigid plastic material, in order for the closure carrier 6 to be handled satisfactorily as a whole, and in particular to allow for easy connection with the microtitre plate 1 and its reaction vessels 2.

Not represented in the drawing is a design which allows for the easy dripping of condensation from the underside of the closure section 4 in that this is designed with a camber in a downwards direction.

It has been explained in relation to the prior art that individual closure elements 3 are also known which feature a thin membrane, through which the interior of the individual reaction vessels can be reached with a needle. The represented and preferred embodiment shows a design such as this, namely a design in which the closure section 4 features a membrane section 4a capable of being perforated. This can be achieved by means of a central passage point 5a in the securing section 5. Both are shown in FIG. 5. The design of the closure section 4, in a relatively soft rubber-elastic plastic material, in particular a thermoplastic elastomer, offers the possibility, to the purpose, that a penetration hole in the membrane section 4a of the closure section 4 will close again of its own accord, because the thermoplastic elastomer has sufficient resetting force.

It is of course possible, when selecting different materials, to make these of different colors, or to have the individual closure devices 3 colored differently to the closure carrier 6. It is of course also possible for the individual closure elements 3 to have colors which differ from one another, for example in this way to combine information relating to the contents of the individual reaction vessels 2. The latter is indicated in FIG. 2 by the different grey shades of the two individual closure elements 3 which can be identified therein.

FIG. 6 finally shows in an enlarged representation the actuation tool 11, with the positive-fit closure element 12 located in it and, if appropriate, a spring-loaded pressure tenon 13, which provides the fixing of the bayonet closure element to the closure handling device 10 of the individual closure element 3. Many other designs are of course also conceivable for corresponding actuation tools 11. Provision can also be made for the spring force for fixing the bayonet closure element to be provided by the inherent elasticity of the closure section 4. In the embodiment shown, for this purpose the pressure tenon 13 is located in the passage point 5a immediately on the material of the closure section 4, so that this additional function is provided.

FIG. 3 shows the closure carrier 6 of an arrangement according to the invention, FIG. 2 shows the closure carrier 6 fitted with individual closure elements 3. Such closure carriers are also inherently commercially viable elements, which are therefore subject to individual protection. The same applies accordingly to the individual closure elements 3.

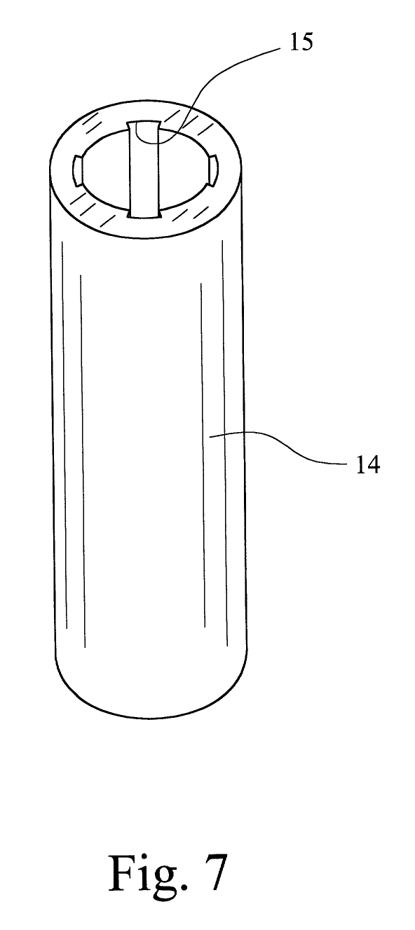

FIG. 7 shows in diagrammatic form an example of a storage and dispensing arrangement 14 for individual closure elements 3 of the type under discussion. This is equipped with its own positive-fit arrangement 15, which interacts with the positive-fit arrangement of the individual closure element 3, namely the tenon parts 8 on the securing section 5, in such a way that the individual closure elements 3 can be issued in precisely predetermined and specific lateral orientation from the storage and dispensing arrangement 14. It is thus possible for the fitting either of the closure carrier 6 with the individual closure elements 3 to be effected, or also for the direct fitting of the reaction vessels 2 without the closure carrier 6.

The arrangement of the invention is a applicable in particular in combination with an industrial robot. That means that the actuation tool 11 can be an active tool of an industrial robot that comprises a fixation for carrying the reaction vessels 2. That means that the actuation tool 11 is not handled by hand but by the corresponding moveable equipment of an industrial robot.

What is claimed is:

1. An arrangement for the contamination-free processing of reaction sequences, compromising:
at least two reaction vessels open to the top, arranged next to one another and connected to one another,
an individual closure element per reaction vessel with a closure section for the tight sealing of the aperture of the reaction vessel and an actuating section for engagement at the individual closure element, and
a closure carrier covering all the reaction vessels or groups of reaction vessels, each with a socket for the actuation section of each individual closure element for securing the individual closure element to the closure carrier,
whereby the individual closure elements secured to the closure carrier can be placed onto the reaction vessels such as to form a seal, and can be drawn off them, wherein
the closure sections of the individual closure elements are capable of being inserted through the sockets in the closure carrier in both directions, and
the individual closure elements are secured to the closure carrier in such a way that, with the closure carrier placed on the reaction vessels with individual closure elements, each individual closure element can be individually removed from the closure carrier and from the reaction vessel.

2. The arrangement according to claim 1, wherein the reaction vessels are arranged on a microtitre plate.

3. The arrangement according to claim 1 or 2, wherein the individual closure elements are secured to the closure carrier by a releasable positive-fit connection between the actuation section and the socket.

4. The arrangement according to claim 3, wherein the positive-fit connection is designed such that when the individual closure element is inserted in the socket, a slight lateral displacement of the individual closure device in the socket is permitted.

5. The arrangement according to claim 4, wherein the positive-fit connection is a bayonet closure element.

6. The arrangement according to claim 5, wherein the positive-fit connection comprises a tenon part arranged at the individual closure element and the link section of the positive-fit connection is arranged at the closure carrier.

7. The arrangement according to claim 6, wherein the positive-fit connection is a bayonet closure element, capable of actuation in both directions of rotation, and comprises a latch element which can be overcome.

8. The arrangement according to claim 3, wherein the positive-fit connection is a quick screw connection.

9. The arrangement according to claim 3, wherein the positive-fit connection is a snap connection.

10. The arrangement according to claim 1 or 2, wherein the individual closure elements are secured to the closure carrier a non-positive connection between the actuation section and the socket.

11. The arrangement according to claims 1, wherein the individual closure elements comprises a closure handling device for engaging an actuation tool which serves to handle a single individual closure element.

12. The arrangement according to claim 11, wherein the closure handling device is a positive-fit element, to which an appropriate positive-fit element on the actuation tool corresponds.

13. The arrangement according to claim 12, wherein the closure handling device comprises a link part, and the positive-fit connection element at the actuation tool comprises a tenon part, of a bayonet closure device.

14. The arrangement according to claim 13, wherein the bayonet closure after establishment of the bayonet closure engagement, a rotation of the individual closure element inserted in the socket is permitted in both directions of rotation.

15. The arrangement according to claim 11, wherein the closure handling device comprises a quick screw connection.

16. The arrangement according to claim 11, wherein the closure handling device comprises a snap connection.

17. The arrangement according to claim 11, comprises the closure handling device comprises a non-positive fit element, to which a corresponding non-positive fit element on the actuation tool corresponds.

18. The arrangement according to claim 3, wherein the positive-fit closure connection or non-positive fit connection is arranged on the outside at the actuation section of the individual closure element and the closure handling device is arranged on the interior at the individual closure element.

19. The arrangement according to claim 1, wherein the closure section of the individual closure element overlaps the reaction vessel.

20. The arrangement according to claim 1, wherein the closure section of the individual closure element enters into the reaction vessel to form a plug.

21. The arrangement according to claim 1, wherein the closure section comprises a camber facing downwards.

22. The arrangement according to claim 1, wherein the closure section comprises a membrane section which can be penetrated.

23. The arrangement according to claim 1, wherein the securing section of the individual closure element consists of a relatively hard, rigid plastic material, and the closure section is a material fit therewith and consists of a relatively soft rubber-elastic plastic material.

24. The arrangement of claim 23, wherein the soft rubber-elastic plastic material is a theremoplastic elastomer.

25. The arrangement according to claim 23, wherein the securing section comprises a central passage point, which extends as far the closure section.

26. The arrangement according to claim 1, wherein the individual closure elements and the closure carrier consist of relatively hard, rigid plastic material.

27. A closure carrier comprising individual closure elements for an arrangement one socket each for an actuation section of an individual closure element for securing the individual closure element to the closure carrier, wherein the formation of the sockets as positive-fit elements of a positive-fit connection or as a non-positive fit element of a non-positive fit connection.

28. The closure carrier according to claim 27, wherein the positive-fit connection is designed such that when the individual closure element is inserted in the socket, a slight lateral displacement of the individual closure device in the socket is permitted.

29. The closure carrier according to claim 28, wherein the positive-fit connection is a bayonet closure element.

30. The closure carrier according to claim 29, wherein the positive-fit connection comprises a tenon part arranged at the individual closure element and the link section of the positive-fit connection is arranged at the closure carrier.

31. The closure carrier according to claim 30, wherein the positive-fit connection is a bayonet closure element, capable of actuation in both directions of rotation, and comprises a latch element which can be overcome.

32. The closure carrier according to claim 27, wherein the positive-fit connection is a quick screw connection.

33. The closure carrier according to claim 27, wherein the positive-fit connection is a snap connection.

34. An individual closure element for a reaction vessel of an arrangement for the contamination-free processing of reaction sequences, comprising a closure section for the seal-tight closure of an aperture of a reaction vessel allocated thereto, and an actuation section for the engagement and handling of an individual closure element, wherein the actuation section is a positive-fit closure element of a positive-fit connection or a non-positive closure element of a non-positive connection.

35. A storage and dispensing arrangement for individual closure elements for an arrangement for the contamination-free processing of reaction sequences, comprising an individual closure element having a positive-fit formation at an actuation section, wherein the positive-fit formation at the actuation section of the individual closure element interacts with a positive-fit formation at the storage and dispensing arrangement in such a way that the individual closure elements can be issued in a predetermined and specific lateral direction from the storage and dispensing arrangement.

36. The arrangement according to claim 11, wherein the actuation tool is an active tool of an industrial robot that comprises a fixation for carrying the reaction vessels.

37. The arrangement according to claim 10, wherein the positive-fit closure connection or non-positive fit connection is arranged on the outside at the actuation section of the individual closure element and the closure handling device is arranged on the interior at the individual closure element.
